(19) United States
(12) Patent Application Publication
(10) Pub. No.: US 2020/0075044 A1
(43) Pub. Date: Mar. 5, 2020

(54) SYSTEM AND METHOD FOR PERFORMING MULTI-MODEL AUTOMATIC SPEECH RECOGNITION IN CHALLENGING ACOUSTIC ENVIRONMENTS

(71) Applicant: CloudMinds Technology, Inc., Santa Clara, CA (US)

(72) Inventors: Charles Robert JANKOWSKI, JR., Fremont, CA (US); Ruixi LIN, Santa Clara, CA (US)

(73) Assignee: CloudMinds Technology, Inc., Santa Clara, CA (US)

(21) Appl. No.: 16/543,608

(22) Filed: Aug. 18, 2019

Related U.S. Application Data
(60) Provisional application No. 62/726,194, filed on Aug. 31, 2018.

(51) Int. Cl. G10L 25/84; G10L 17/18; G10L 17/04; G10L 21/02

(52) U.S. Cl. CPC G10L 25/84; G10L 17/18; G10L 21/0264; G10L 21/0202; G10L 17/04

(57) ABSTRACT

A speech recognition method includes: providing a system having a local computational device, the local computational device having a microphone, processing circuitry, and a non-transitory computer-readable medium; recording a raw audio waveform utilizing the microphone; determining a background noise condition for the raw audio waveform; comparing the background noise condition to a plurality of linguistic models having associated background noise conditions; determining a nearest match between the background noise condition of the raw audio waveform and the associated background noise condition of at least one of the plurality of linguistic models; and performing an automatic speech recognition (ASR) function between the raw audio waveform and the linguistic model having the matching associated background noise condition.

### CROSS-REFERENCE TO RELATED APPLICATION

The present application claims priority to United States Provisional Patent Application No. 62/726,194 filed on Aug. 31, 2018, the disclosure of which is hereby incorporated by reference in its entirety.

### TECHNICAL FIELD

The present disclosure relates to performing automatic speech recognition (ASR) or Voice Activity Detection (VAD) as well as speech-to-text (STT) in noisy conditions.

### BACKGROUND

VAD or ASR can be described as techniques used to determine whether recorded raw audio contains speech or not, and to determine the exact position of speech within an audio wave form. VAD is often used as a first step in a speech processing system wherein STT is typically a secondary process wherein the identified speech is translated into the textual characters which describe the determined speech. ASR performs quite well, sometimes even better than humans, in quiet conditions with a close talking microphone (right next to the speaker). Performance breaks down considerably, though in high noise environments and/or mid- or far-field use cases where the speaker is 0.5 m or more away from the microphone(s).

### SUMMARY

In an aspect, a speech recognition method is provided, including:

providing a system having a local computational device, the local computational device having a microphone, processing circuitry, and a non-transitory computer-readable medium;

recording a raw audio waveform utilizing the microphone;

determining a background noise condition for the raw audio waveform;

comparing the background noise condition to a plurality of linguistic models having associated background noise conditions;

determining a nearest match between the background noise condition of the raw audio waveform and the associated background noise condition of at least one of the plurality of linguistic models; and

performing and automatic speech recognition (ASR) function between the raw audio waveform and the linguistic model having the matching associated background noise condition.

In some such embodiments, the method can include the steps of:

providing a remote server; providing a database containing a plurality of linguistic models and associated background noise conditions for each linguistic model; and

providing a computerized neural network on the remote server;

wherein the computerized neural network is configured to determine the nearest match between the background noise condition of the raw audio waveform and the associated background noise condition of a particular linguistic model.

In some such embodiments, the method can include the steps of:

providing a database containing a plurality of linguistic models and associated background noise conditions for each linguistic model;

providing a computerized neural network on the local device;

wherein the computerized neural network is configured to determine the nearest match between the background noise condition of the raw audio waveform and the associated background noise condition of a particular linguistic model.

It will be appreciated that in some embodiments, the computerized neural network can be compressed.

In some embodiments, the method can include the steps of: extracting textual characters representing speech within the raw audio waveform.

Upon presenting the textual characters to a user, the method can then include additional steps of: tracking user interactions with the local computational device; and determining corrections to the textual characters extracted from the raw audio waveform.

If corrections are detected, such corrections can be utilized to generate a new linguistic model with an associated background condition based on an original base truth from an original linguistic model and creating a new linguistic model based on an extracted background noise condition; wherein the method can then include the step of inserting the new linguistic model into the plurality of linguistic models contained on the database for future consideration by the computerized neural network in future match determination functions.

In some embodiments, each of the plurality of linguistic models can be representative of a single language model recorded in a plurality of associated noise condition, wherein the only variation between each linguistic model is their particular associated noise conditions.

Alternatively, in some other embodiments, the plurality of linguistic models can include a plurality of language models, each being recorded in a plurality of associated noise condition, wherein each linguistic model can vary with regard to particular associated noise conditions as well as an underlying language represented thereby.

It will then be appreciated that associated systems for performing the contemplated method are contemplated herein wherein the system can include local computational devices, which can include microphones, processing circuitry, user interfaces, etc.

Further, the method steps can each be completed remotely, however the system can also be provided with a communication system which can instead be utilized to transmit information to perform some of, or all of the steps, on a remote server, etc.

In another aspect, a speech recognition system is provided, including:

a local computational system, the local computational system further including:
processing circuitry;
a microphone operatively connected to the processing circuitry;

a non-transitory computer-readable media being operatively connected to the processing circuitry;

a remote server configured to receive recorded wavelengths from the local computational system; the remote server having one or more computerized neural networks, wherein the computerized neural networks of the remote server are trained on a plurality of acoustic models, wherein each of the plurality of acoustic models represent a particular linguistic dataset recorded in one or more associated noise predetermined signal to noise ratios;

wherein the non-transitory computer-readable media contains instructions for the processing circuitry to perform the following tasks:
utilizing the microphone to record raw audio waveforms from an ambient atmosphere;
transmitting the recorded raw audio waveforms to the remote server; and

wherein the computerized neural network is configured to determine the nearest match between the background noise condition of the raw audio waveform and the associated background noise condition of a particular linguistic model.

In some embodiments, the computerized neural network is further configured to extract textual characters representing speech within the raw audio waveform.

In some embodiments, the computerized neural network is further configured to track user interactions with the local computational device and determine corrections to the textual characters extracted from the raw audio waveform.

In some embodiments, the computerized neural network is further configured to generate a new linguistic model with an associated background condition based on an original base truth from an original linguistic model and creating a new linguistic model based on an extracted background noise condition; and insert the new linguistic model into the plurality of linguistic models contained on the database for future consideration by the computerized neural network in future match determination functions.

In some embodiments, each of the plurality of linguistic models are representative of a single language model recorded in a plurality of associated noise condition, wherein the only variation between each linguistic model is their particular associated noise conditions.

In some embodiments, the plurality of linguistic models include a plurality of language models, each being recorded in a plurality of associated noise condition, wherein each linguistic model can vary with regard to particular associated noise conditions as well as an underlying language represented thereby.

In another aspect, a robotic apparatus is provided, including a speech recognition system, the system including:

a local computational system, the local computational system further comprising:
processing circuitry;
a microphone operatively connected to the processing circuitry;

a non-transitory computer-readable media being operatively connected to the processing circuitry;

one or more computerized neural networks;

wherein the non-transitory computer-readable media contains instructions for the processing circuitry to perform the following tasks:

utilize the microphone to record raw audio waveforms from an ambient atmosphere; and

wherein at least one computerized neural network is configured to wherein the computerized neural network is configured to determine the nearest match between the background noise condition of the raw audio waveform and the associated background noise condition of a particular linguistic model.

In some embodiments, the computerized neural network is further configured to extract textual characters representing speech within the raw audio waveform.

In some embodiments,

the computerized neural network is further configured to track user interactions with the local computational device and determine corrections to the textual characters extracted from the raw audio waveform, and

the computerized neural network is further configured to generate a new linguistic model with an associated background condition based on an original base truth from an original linguistic model and creating a new linguistic model based on an extracted background noise condition; and insert the new linguistic model into the plurality of linguistic models contained on the database for future consideration by the computerized neural network in future match determination functions.

In some embodiments, each of the plurality of linguistic models are representative of a single language model recorded in a plurality of associated noise condition, wherein the only variation between each linguistic model is their particular associated noise conditions.

In some embodiments, the plurality of linguistic models include a plurality of language models, each being recorded in a plurality of associated noise condition, wherein each linguistic model can vary with regard to particular associated noise conditions as well as an underlying language represented thereby.

It should be understood that both the foregoing general description and the following detailed description are exemplary and explanatory only and are not restrictive of the disclosure. Other aspects and embodiments of the present disclosure will become clear to those of ordinary skill in the art in view of the following description and the attached drawings.

### BRIEF DESCRIPTION OF THE DRAWINGS

To more clearly illustrate some of the embodiments, the following is a brief description of the drawings.

The drawings in the following descriptions are only illustrative of some embodiments. For those of ordinary skill in the art, other drawings of other embodiments can become apparent based on these drawings.

FIG. 1A illustrates an exemplary system which can be utilized for performing various functions and implementing various method steps in accordance with various aspects of the present invention;

FIG. 1B illustrates a comparison between various environments;

FIG. 1C is a block diagram illustrating a multi-model ASR system;

FIG. 2 illustrates an alternative exemplary system which can be utilized for performing various functions and implementing various method steps in accordance with various aspects of the present invention;

FIG. 3 illustrates an exemplary flow chart illustrating various steps and methods which can be implemented by the systems illustrated in FIGS. 1A-2 in accordance with various aspects of the present invention;

FIG. 4 illustrates an additional exemplary flow chart illustrating various steps and methods which can be implemented by the systems illustrated in FIGS. 1A-2 in accordance with various aspects of the present invention;

FIG. 5 illustrates an additional exemplary flow chart illustrating various steps and methods which can be implemented by the systems illustrated in FIGS. 1A-2 in accordance with various aspects of the present invention;

FIG. 6 illustrates an additional exemplary flow chart illustrating various steps and methods which can be implemented by the systems illustrated in FIGS. 1A-2 in accordance with various aspects of the present invention;

FIG. 7A illustrates a graph of Character Error Rates (CERs) of various systems as a function of SNR;

FIG. 7B illustrates condition identification accuracy by feature, for various numbers of training utterances;

FIG. 7C illustrates a graph of CERs of various training schemes as a function of SNR; and

FIG. 8 illustrates a graph of CERs for various training schemes as a function of hours of training data having various associated noise conditions.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. can be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or other structure is referred to as being “on” or extending “onto” another element, it can be directly on or extend directly onto the other element or intervening elements can also be present. In contrast, when an element is referred to as being “directly on” or extending “directly onto” another element, there are no intervening elements present.

Likewise, it will be understood that when an element such as a layer, region, or substrate is referred to as being “over” or extending “over” another element, it can be directly over or extend directly over the other element or intervening elements can also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Relative terms such as “below” or “above” or “upper” or “lower” or “vertical” or “horizontal” can be used herein to describe a relationship of one element, layer, or region to another element, layer, or region as illustrated in the drawings. It will be understood that these terms and those discussed above are intended to encompass different orientations of the device in addition to the orientation depicted in the drawings.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The inventors of the present disclosure have recognized that the improvement of ASR and STT can improve the accuracy, applicability, and versatility of voice-controlled systems.

In particular, Social robots deployed in public spaces present a challenging task for ASR because of a variety of factors which often present themselves in these public places, including variations in Signal to Noise Ratios (SNR) which can range between 20 to 5 dB. While existing Automatic Speech Recognition ASR models and systems perform well for higher SNRs in this range, their performance typically degrade considerably with increased noise or low SNRs. This is because current ASR systems are typically trained in low noise conditions on a single linguistic model which then have increasing difficulty recognizing speech with a corresponding increase in background noise, i.e. as the SNR decreases.

Conventional VAD systems typically are only trained only on a single linguistic model with the models being recorded only in low noise environments, as such, these models only provide acceptable speech recognition in low-noise situations and degrade drastically as the noise level increases. Further, conventional systems typically only extract a single type of Mel Frequency Cepstral Coefficient (MFCC) features from the recorded raw audio waveforms resulting in the voice recognition which is unable to adapt to numerous types or background noise. In the real-world, users who may rely on VAD interfaces often encounter wide ranging noise levels and noise types that often render previous VAD systems unsuitable.

Examples of situations in which VAD and speech-to-text systems might be used in high-noise situations can include utilizing a smart device in an airport, in a vehicle, or in an industrial environment. However, where many users may just suspend use of VAD devices until exiting such environmental conditions, some users may be dependent on such devices and may require the VAD to perform even in these environments. Examples may include users with degenerative neural diseases, etc. which users may not have an option of exiting an environment or communicating using alternative means. Improvement in VAD systems will allow for more versatile uses and increased ability for users to depend on said systems. Additionally, increased reliability of VAD systems in noisy conditions may also allow for additional communication and voice command sensitive systems in previously non-compatible systems, for example vehicular systems, commercial environments, factory equipment, motor craft, aircraft control systems, cockpits, etc.

However, VAD system improvements will also improve performance and accuracy of such systems even in quiet conditions, such as for smart homes, smart appliances, office atmospheres, etc.

Contemplated herein are various methods for providing improved ASR performance in such conditions by providing a system having a plurality of models, each model being trained utilizing various linguistic models with varying corresponding SNR's and varying background conditions.

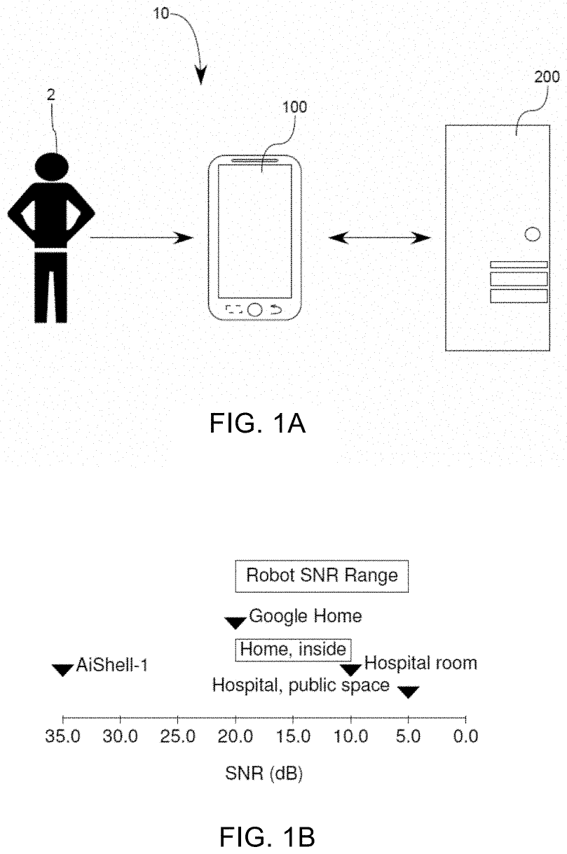

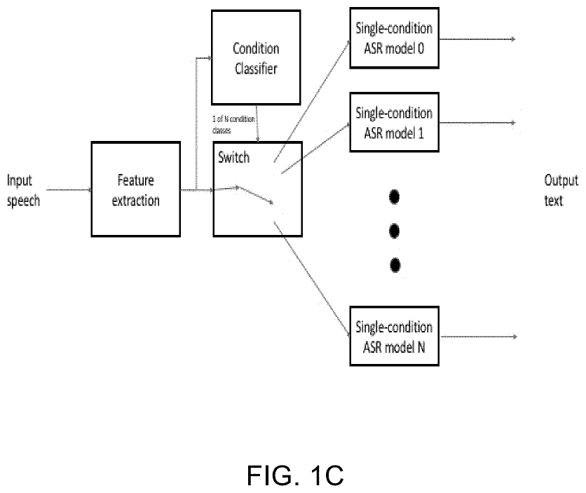

In order to implement these methods, contemplated herein is a system 10 which utilizes a known VAD system which receives raw audio waveform from a user 2, performs VAD classification on a local computational device, i.e. a smart device, and sends the result to a cloud-based AI platform. This flow can be seen in FIG. 1A and described as follows: a user 2 speaks into the smart device 100, which device includes a microphone, processing circuitry, and non-transitory computer-readable media containing instructions for the processing circuitry to complete various tasks.

Using the smart device 100, audio is recorded as a raw audio waveform; the VAD 10 system transforms the raw audio waveform and classifies as speech or non-speech; the speech audio waveform is then sent to a Cloud-based AI platform 200 for further speech processing, the AI platform determines a particular background noise and matches the raw audio waveform with a particular linguistic model which has been recorded having a similar background noise condition. Then, a classifier compares the raw audio waveform to one of a particular linguistic model used to train the classifier having a particular matching background noise condition so as to improve accuracy of the particular speech-to-text or voice activation detection.

In other words, the system as contemplated herein can train an ASR system with a particular linguistic model with intentional background noise, wherein during the training process the system can have a base truth input associated wherein the base truth is input in association with a variety of background conditions. For example, a linguistic model can be recorded based on an AiShell-1 Chinese speech corpus and the Kaldi ASR toolkit with a typical airport, factory, freeway, vehicular, machinery, wind, office conversation background noise overlayed onto the linguistic model. In such situations, the system can save each particular background overlay as a separate and distinct model for comparison between recorded raw audio waveforms for purposes of performing ASR on the raw audio waveform.

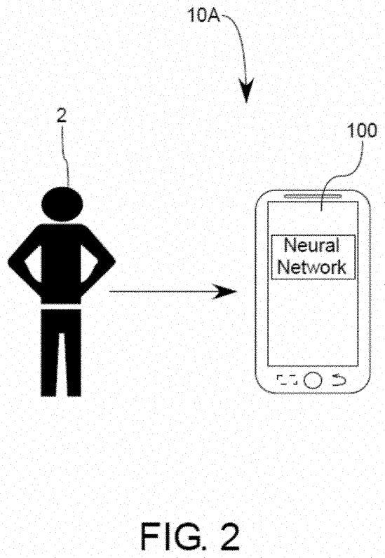

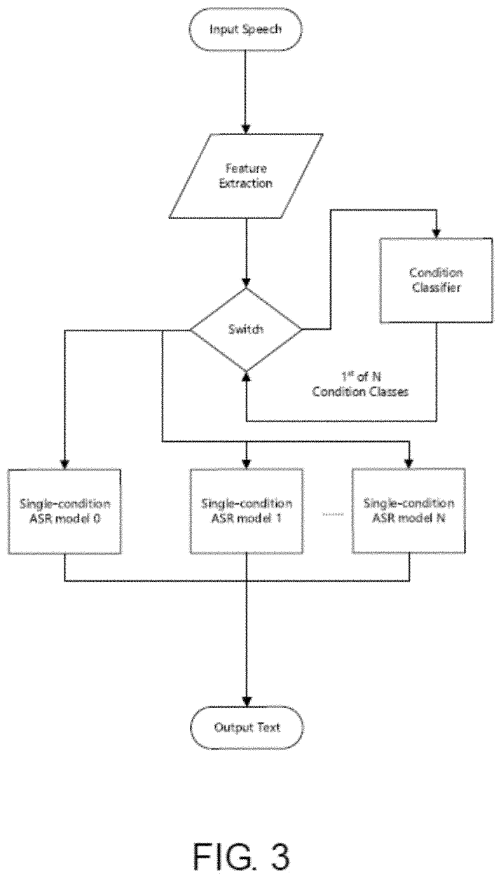

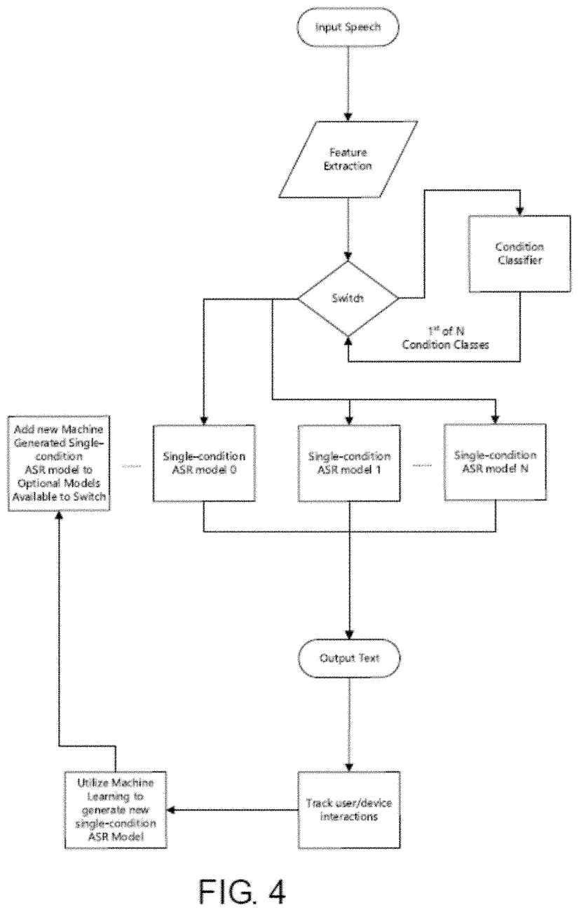

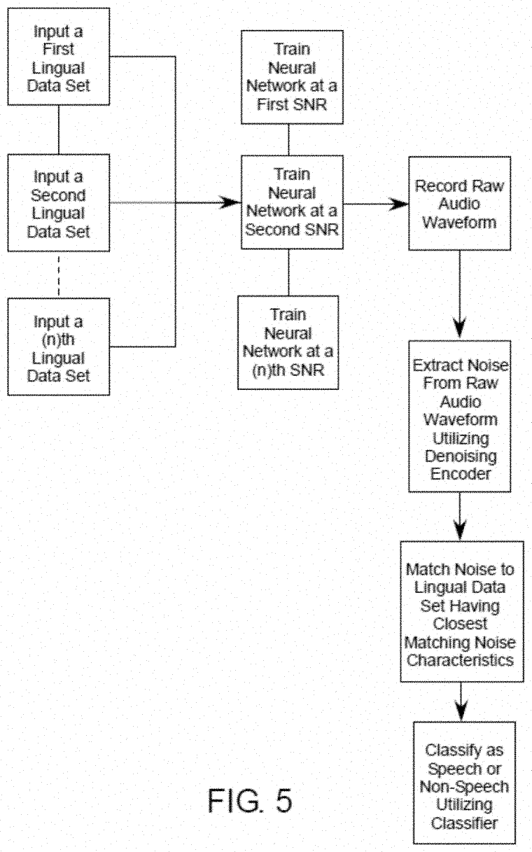

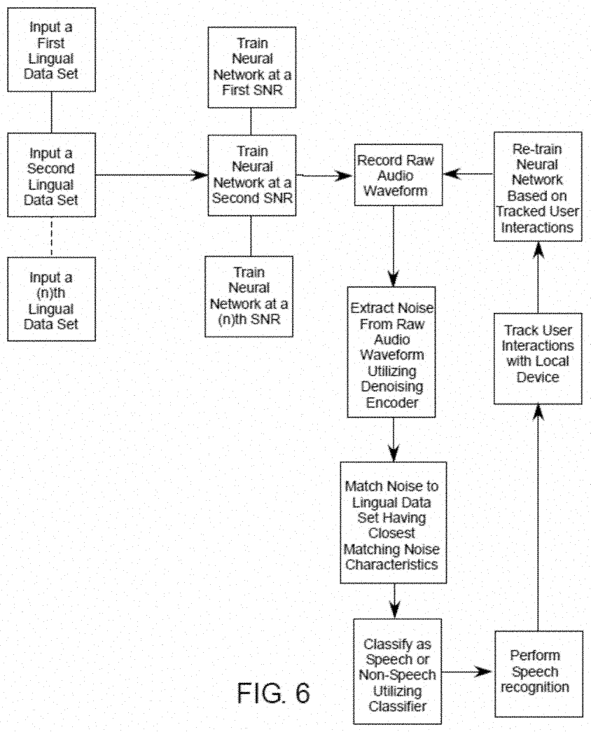

It will then be appreciated that the smart device as discussed here is only offered as an exemplary implementation wherein any computational device may be used. Further, while the cloud-based AI platform as discussed here is only offered as an exemplary implementation wherein any machine learning as discussed herein may also be implemented locally such as in the implementation illustrated in FIG. 2 by system 10A, wherein this exemplary embodiment is only made for purposes of providing an exemplary framework in which to discuss the methods and steps forming a core of the inventive concepts discussed herein.

In some embodiments, various base linguistic models can be utilized in a similar wide variety of conditional background noise overlays to add robustness to the system. In other words, an AiShell-1 Chinese linguistic model can be recorded in a plurality environments having various background noise situations at a plurality of associated SNRs, wherein each recording is associated with a base truth input, and wherein each recording is saved as an independent linguistic model, then an alternative linguistic model such as English VoxForge™ can be similarly recorded in another similar corresponding set of background noise levels, varying environments, with associated background noise overlays etc. such that a plurality of linguistic models are provided having a robust number of associated SNR's, environments, etc.

The system can then utilize a local computational system or terminal, such as a smartphone having local processing circuitry, microphone, and network connectivity so as to record raw audio waveforms. Such a system can then utilize a electronic switch, which can compare background noise of an ambient environment of the device to determine an optimal linguistic model as discussed above having been recorded in or otherwise having appropriate SNR and associated background environment for performing ASR utilizing a particular linguistic model having a background noise and SNR level most closely matching the current location as detected by the local system.

For purposes of discussion and context various environments were measured wherein the following Table 1 illustrates various T₆₀ scores for these real-world environments.

TABLE 1
T₆₀ scores for various acoustic environments

| Environment | T₆₀ |
|---|---|
| Home | 0.55 |
| Office | 0.4-0.7 |
| Mall | 1.7-3.2 |
| Airport | 3+ |

There are several factors the influence ASR performance in challenging conditions. Performance in this case is typically quantified by word error rate (WER) or character error rate (CER) for Asian languages. These factors may include the following.

Vocabulary: the perplexity of the language model has a significant inverse effect on performance.

Microphone distance: speakers further away from the microphone, especially in acoustically active rooms, can result in substantially lower performance.

Noise: one of the biggest factors affecting ASR performance is the noise level, typically quantified as signal-to-noise ratio (SNR).

Reverberation: highly reverberant acoustic environments are particularly challenging. Reverberation time is typically quantified by T₆₀, or the time in seconds for sounds in a room to decay by 60 dB.

In order to illustrate the limitations of the prior art raw speech from various real-world environments was recorded and the associated noise conditions were tracked wherein some of these deployments and measured the noise conditions, notably signal-to-noise-ratio (SNR) measured similarly to the table above, and compared to SNRs from other well-known conditions and environments. FIG. 1B shows a comparison between various environments.

As shown from FIG. 1B, public deployments of robots normally operate from 15-20 dB SNR for a relatively quiet office, to 5-7 dB for a loud trade show in a very reverberant environment. This is in contrast, for example, to home-based social robots such as Alexa™ or Google Home™, which experience an SNR of about 20 dB. It will then be understood that many ASR systems perform very well in clean or 20 dB SNR speech, but start degrading past 20 dB, and show quite substantial errors at 10 dB SNR and beyond.

FIG. 1C is a block diagram illustrating a multi-model ASR system according to some embodiments disclosed herein. The ASR system can be implemented in a robotics system, for example, a home, office, or hospital robotic assistant, etc.

The input speech, when received by the robot, can have its features extracted by a feature extraction module. Based on the features extracted and the condition received from the condition classifier, a switch can switch among a single-condition ASR model 0, a single-condition ASR model 1, . . . , a single-condition ASR model N. Using the optimal ASR model(s), text can be output for display and/or for commanding the robot to execute actions according to the recognized commands.

The various device components, blocks, or portions may have modular configurations, or are composed of discrete components, but nonetheless may be referred to as “modules” in general. In other words, the “modules” referred to herein may or may not be in modular forms.

The following Table 2 summarizes some of these factors that contribute to ASR performance, for the popular Alexa/Google Home voice bot devices as well as several of the research challenges such as CHiME and REVERB.

TABLE 2
Factors affecting ASR performance

| | | Microphone | SNR | | |
|---|---|---|---|---|---|
| Use case/challenge | Perplexity | distance (m) | (dB) | T₆₀ | WER |
| Alexa/Google Home (2016) | Medium | 2 | 20 | 0.5 | 20 |
| CHiME-1: Binaural living room (2011) [4] | 6.3 | 2 | 9 to −6 | 0.3 | 8.2@6 dB |
| CHiME-2: CHiME-1 + More vocab + spk movement | 6.3, 110 | 2 | 9 to −6 | 0.3 | 4, 17 @ 6 dB |
| (2013) [5] | | | | | |
| REVERB: Single speaker in office room (2013) [9] | | 1, 2.5 | 20 | 0.7 | 30-50 (8-1 mics) |
| CHiME-3: Tablet with 6 mics outside (2015) [6] | | 0.4 | 5 | 0 | 5.8 |
| CHiME-4: CHIME 3 + 1, 2, 6 mics (2016) [7] | | 0.4 | 5 | 0 | 2.2, 3.9, 9.2 |
| CHiME-5: Dinner party with multiple talkers (2018) [8] | | 2 | Low | 0.5 | 46 |
| Robots at trade shows | Medium/Low | 1 | 15 to 5 | 1+ | >50 |

As can be seen from Table 2, the WER can be observed from deploying physical social robots in these various conditions utilizing various known ASR systems.

For purposes of comparison, the AiShell-1 Chinese corpus can be used for initial evaluation wherein the AiShell-1 has speech recordings using a high-quality microphone, Android mobile device, and iOS mobile device.

Up to now, the system can be operated utilizing only the 178-hour open-source part of the AiShell corpus has been used. Up to 718 additional hours of data per recording setup could be acquired if needed. It will then be understood that AiShell-1 comes with pre-partitioned training, development, and test sets of 118664, 14326, and 7176 utterances or 148, 18, and 10 hours, from 336, 40, and 20 speakers. These splits can then be used for all training and testing.

In order to create noisy data, recorded noise can be added to the relatively clean AiShell-1 data to create noisy data, for example around 35 dB SNR. This gives the system an immediate large corpus of noisy data which would have been challenging to collect in the field. It will then be understood, that for implementing the methods of the present invention in conjunction with other techniques, such as autoencoders, it is sometimes necessary to have both clean and corrupted samples from the same data.

The system can then be trained utilizing SNR increments of 5 dB from 20 dB to 0 dB, wherein the noise level can then be scaled to obtain the needed average SNR across a sample of the corpus.

In the embodiments discussed herein only one noise level was used for a given SNR for the entire corpus, e.g., there is utterance-by-utterance variability in the SNR, but the average is the desired SNR.

For a given average SNR condition, the standard deviation of SNR across utterances is 5 dB.

The base noise used for adding to the corpus can then be recorded from a social robot deployed in a real-world environment, for example, the current system utilized a social robot being deployed at the Mobile World Congress trade show in February 2018.

This noise is often advantageous as it represents more realistic noise than white or pink generated noise.

In this implementation a one-minute section of audio was extracted from the raw recording, where there was only background and environmental speech, i.e., no foreground speech. The recordings were made from the front main microphone of a device very much like an Android mobile phone.

For each utterance in the training and test corpora, a random piece of that one-minute segment was used as the noise portion, to ensure randomness in the added noise.

In some embodiments an open-source Kaldi Chinese model can be utilized as another alternative linguistic model. This model uses a chain variant of the Kaldi TDNN, with 40-dimensional filter bank output as features instead of MFCC. Pitch features are not used, and i-vectors are not used for speaker adaptation. The acoustic model can be trained on over 2000 hours of speech, and the language model can be trained on a 1 TB news corpus.

It will then be understood that in some instances it makes more sense to utilize a character error rate (CER), which is a standard measure used for Chinese as opposed to word error rate (WER) for many other languages.

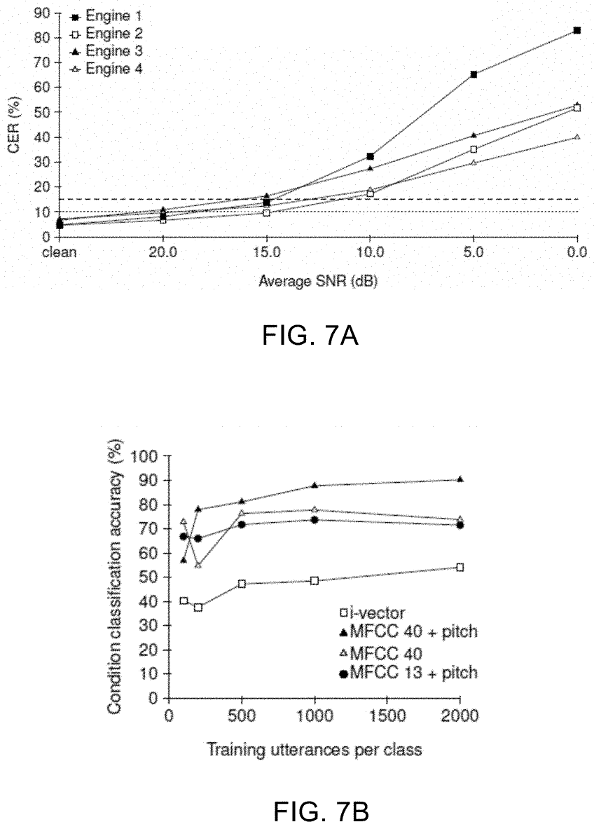

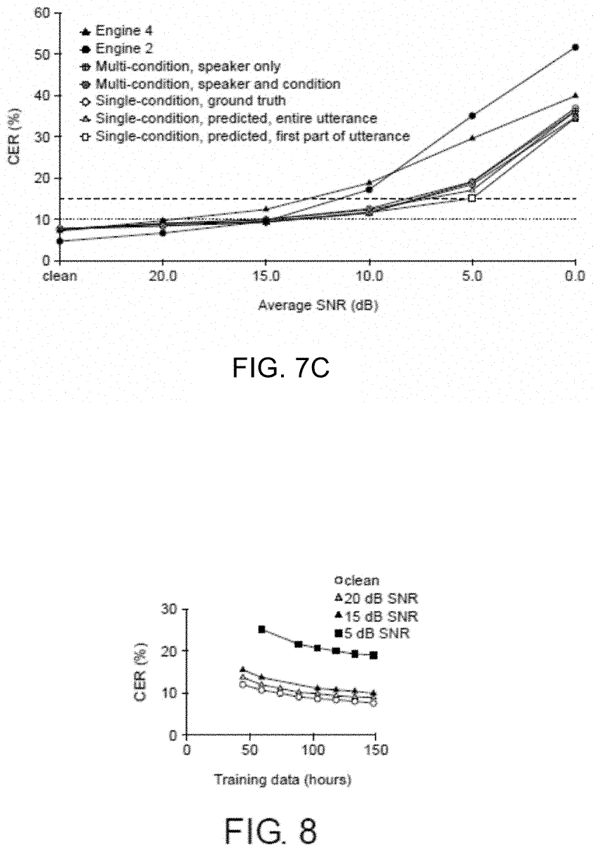

FIG. 7A then illustrates various CER, using the various 3rd-party APIs and open-source models on clean and noisy data. It can be seen that for an example range of SNR for robot deployments, as well as a dotted line at 10% CER and a dashed line at 15% CER. For CER exceeding 10-15%, the usability of system is questionable.

From FIG. 7A it will be appreciated that that these models perform very well in clean speech and low noise, but CER increases substantially with higher noise, especially at SNR lower than 15 dB. The extent that the model worsens with more noise is quite system dependent. However, given that performance is degrading in the operating region for robots, it is worth investigating methods, such as those contemplated herein in order to reduce error rates for SNR less than 15 dB.

As discussed above, the system contemplated herein performs ASR by doing comparisons of the raw audio waveforms to linguistic models having been trained on noisy data rather than on clean data.

The particular experiments discussed herein utilized a combination of AiShell and Kaldi linguistic models, which utilize monophone then triphone-based GMM models, using first MFCCs plus deltas and then multiple-frame LDA plus MLLT, then speaker adaptation using fMLLR, and finally the DNN “chain” model incorporating various online iVectors for speaker characteristics.

For fair comparison with 3rd party ASR APIs, which handle a wide variety of text, it can be important to use a more general language model than the one trained only on AiShell data, which is the default in the Kaldi recipe. The complexity of such general language models will be significantly higher, thus resulting in lower ASR accuracy, compared to language models trained only on the ASR training corpus.

In order to overcome this the system can also be configured to utilize the Sogou Chinese news corpus, which contained roughly 600 GB of text. A trigram language model can then be built using Witten-Bell smoothing and appropriate pruning to be computationally feasible without sacrificing much performance.

In some embodiments the various acoustic comparison models can then be trained with the original AiShell-1 training set of 148 hours, plus noisy versions of the training set at 20, 15, 10, 5, and 0 dB SNR, for a total training set of 888 hours.

FIG. 7B illustrates condition identification accuracy by feature, for various numbers of training utterances.

In these examples, high-resolution MFCC outperforms standard resolution. MFCC (both resolutions) outperform i-vector. Pitch features may also be useful across the board. Having more than 2000 training samples per class can bring some improvements.

FIG. 7C shows the CER results of the two best performing engines from those as shown in FIG. 7A, as well as the new multi-condition-trained custom models as contemplated herein.

The following Table 3 shows the results for engines from FIG. 7A, as well as the binomial standard deviation, using the minimum of the prior art engines as the baseline, and number of standard deviations by which the custom model exceeds the best results of the prior art engines.

TABLE 3
CER as a function of SNR, including custom model

| ASR | Clean | 20 dB | 15 dB | 10 dB | 5 dB | 0 dB |
|---|---|---|---|---|---|---|
| Eng2 | 4.7 | 6.7 | 9.6 | 17 | 35 | 52 |
| Eng4 | 7.2 | 9.7 | 12 | 19 | 30 | 40 |
| Custom | 6.6 | 7.1 | 8.1 | 10 | 17 | 34 |
| sdev | 0.25 | 0.30 | 0.35 | 0.44 | 0.54 | 0.58 |
| #sdev | −7.6 | −1.4 | 4.3 | 16 | 24 | 10 |

It will then be seen that noise conditions where the custom model exceed performance by more than 4 standard deviations are shown in bold.

For SNRs of 15 dB or less, the custom-trained models performed statistically significantly better than the best of the existing engines. At 20 dB SNR the difference in results are not significant. For clean speech, the existing engines do significantly better, which is expected given the large amount of time and data behind these models.

However, since the goal of the systems contemplated herein is to improve real-world performance of ASR on actual deployed robots, it is imperative to operate with a framework that would readily facilitate deployment of the custom-trained models.

In order to achieve this the systems contemplated herein can use a gStreamer interface to Kaldi and the associated Docker image for this interface to quickly deploy the Kaldi-trained model in appropriate situations.

The system utilizes this infrastructure to deploy the custom models on various social robots in the field. One of many advantages of using the Kaldi toolkit is the small amount of effort needed for deployment, so activities can be focused on model development.

The system can also implement additional linguistic models, such as: English with the Librispeech corpus; Japanese with the CSJ corpus, both of which have established Kaldi recipes; the 1000-hour AiShell-2 corpus.

The system can also implement various variations of microphone arrays, especially for use in local computational systems or social robots which are deployed in public spaces with multiple possible speakers, sometimes simultaneous. Such improvements permitted by use of such multiple microphones allow for better detection of the live speaker and also allow for the system to focus attention on that speaker, which is not enabled in systems utilizing only single microphones.

The typical method for measuring performance of ASR is Word Error Rate (WER), or the minimum number of single-word insertions, deletions, and substitutions that is required to transform the speech recognizer's word string to the “ground truth” word string generated by human annotators. For Asian languages that have words with fewer more complex characters, sometimes Character Error Rate (CER) is used instead.

In terms of quantifying the level of noise, typically signal-to-noise-ratio (SNR) is used. SNR is the difference between the average energy of the speech part of a waveform (in dB) and the average energy of the background noise (also in dB). “Clean” speech typically has SNRs from 30 dB or higher; SNRs for noisy deployments of social robots range from 20 dB to 5 dB.

It has then been recognized that ASR systems are normally trained on a large amount of training speech, several hundred hours or more, where the orthographic transcription the word string of each training utterance has been annotated by human listeners and wherein the recordings of the training speech are typically made in studios wherein the SNR is optimal. The systems' performances are then evaluated using a set of test speech, also with orthographic transcriptions, which usually comes from the same body of data but a completely different subset of that data. None of the utterances, or even speakers, from the training set should be in the testing set, and vice-versa.

One technique, “multi-style training,” involves training a single ASR model on examples of speech from the various noise conditions. Another technique, “single-style training,” involves training a single ASR model on each of the various noise conditions, then choosing which model to use at run-time. It would not be surprising for single-style training to perform better than multi-style training, since the training set for each single-style model has less variability.

To use single-style models, though, one must first need to be able to detect what condition or noise level an utterance has in order for the correct model to be chosen. One would then need the classification of noise level to happen as soon as possible from the beginning of the speech utterance, so as to not incur additional delay in the user getting a response.

In order to solve these and various other problems a system and method is contemplated herein which utilizes a single-condition training to do ASR.

In order to use single condition models, the condition or noise level must be determined.

The technique of ASR in accordance with various aspects of the present invention proceeds during run-time by performing the following steps:

classifying the incoming speech into one of several condition categories;

selecting the single-condition model which can be trained on speech from the chosen condition category; and

performing ASR using the chosen single-condition model and provide the answer.

In order to build a system to do this ASR, the system is configured to:

define a number of noise conditions, based on a sample of actual deployment conditions;

take a large body of speech data and for each noise condition, add an appropriate amount of noise at the same noise level to achieve the desired average SNR or other metric;

build the noise classifier to classify the incoming speech into the conditions; and

train a single-condition model for each condition.

In terms of the noise classifier, there are at least 2 possible ways to generate the various conditions, which can include:

use the condition specified when the noise can be added; and

use unsupervised learning to cluster the samples into a new set of defined “conditions.”

There are in turn several ways to accomplish this:

use a well-known unsupervised learning algorithm such as k-means clustering, using a Euclidean distance metric, to cluster/classify the feature frames into condition;

use such an unsupervised algorithm to generate ground truth by clustering, then use a supervised learning algorithm such as a convolutional neural network (CNN) to classify the frames into condition; and

use the supervised algorithm such as CNN to get an initial estimate of condition classes, then iterate as follows:

start with a model mO resulting in prediction pO of the class using the initial SNR categories as ground truth gO;

make gl=pO; wherein the “new” ground truth is the predicted from the last step;

train the model with gl as ground truth, resulting in model ml giving predicted pI;

save away the trained model ml and predictions pl;

repeat 2 and 3, setting gn=p(n−1) and training the model to get mn and pn.

stop iterating when the pn=p(n−1) for all utterances, or until some kind of iteration counter is exceeded.

In some embodiments, an implementation is contemplated in which a component “Feature extraction” is performed on a speech waveform which produces a periodic vector or “features,” or numbers that represent the important aspects of the speech waveform, wherein the period of the vector is typically every 10 milliseconds.

The stream of feature vectors from the feature extraction is then provided to a “Condition Classifier” which takes the extraction and produces a running estimate of the noise condition of the input speech waveform. That estimate is 1 of N possible symbols, each corresponding to a noise condition, where N is the number of conditions.

A stream of input feature vectors are then provided to one or more single-condition ASR models which take the feature vectors and produce an output text string corresponding to what was spoken in the speech waveform.

The stream of feature vectors from feature extraction are then provided to a component switch that directs the feature vectors to the relevant Single-condition ASR model corresponding to the noise condition that was classified.

The procedure for creating the multi-model ASR system can include one or more steps, including: defining Nc conditions based on the actual expected deployment conditions.

For example: clean (no noise added), 20 dB SNR, 15 dB SNR, 10 dB SNR, 5 dB SNR, 0 dB SNR for Nc=6 conditions. In such instances, the system can be configured to start with a corpus C of speech data wherein C contains Nu speech utterances, wherein corpus C can then be partitioned into 3 distinct sets: a training set ctrain with Nutrain utterances, a development set Cdev with Nu dey utterances, and a test set Ctest with Nutest utterances. In such embodiments, each utterance in corpus C can be classified into one and only one of ctrain Cdev or Ctest;

The procedure for creating the multi-model ASR system can then include a step of artificially modifying corpus C to create Cc, or the original corpus C corrupted by condition c for each condition c, wherein Cc will have the same number Nu of utterances as C. It will then be noted that each utterance in Cc will be the same length as the corresponding utterance in C, but with noise or other corruption added. This modification can be simply adding noise at an appropriate level or creating other linear or nonlinear distortions to model real-world deployment conditions.

The procedure for creating the multi-model ASR system can then include a step of training a single-condition ASR model NIc using only Ce_train for each condition c, i.e. the training portion of Ce.

The procedure for creating the multi-model ASR system can then include a step of training the condition classifier which will at run-time take the feature vector stream and return a running estimate of the which of the Ne conditions are being used.

For the step of training the condition classifier there are several potential options, including: first, using a well-known unsupervised learning algorithm such as k-means clustering, using a Euclidean distance metric, to cluster/classify the feature frames into condition; second, third; using such an unsupervised algorithm to generate ground truth by clustering, then use a supervised learning algorithm such as a convolutional neural network (CNN) to classify the frames into condition; or fourth using the supervised algorithm such as CNN to get an initial estimate of condition classes, then iterate as follows:

start with a model mO resulting in prediction pO of the class using the initial SNR categories as ground truth gO;

make gi=pO; the “new” ground truth is the predicted from the last step;

train the model with gi as ground truth, resulting in model mi giving predicted pl;

save away the trained model ml and predictions pl;

repeat these iterations by setting gn=p(n−I) and training the model to get mn and pn; and

stop iterating when the pn=p(n−I) for all utterances, or until some kind of iteration counter is exceeded.

In some additional embodiments, the system can be utilized for improving performance in noise and other conditions is to train models with conditions that might be expected in the field.

One of the basic training paradigms is multi-condition or multi-style training, where the model is trained on a mix of conditions that are seen in deployment, potentially with the probability of various conditions weighted to reflect the actual deployment environment(s).

As would be expected, multi-condition training introduces significant additional variability on top of an already challenging problem, by mixing various deployment conditions in one model. An alternative would be single-condition training, where the model is trained only on a particular condition, thus removing that element of variability and presumably resulting in higher performance.

In order to utilize single-condition training, a choice among the models is determined for used for the speech to text extraction. The VSR systems according to various embodiments disclosed herein also are able to support the computational requirements of multiple models, e.g., memory, CPU, etc.

As discussed above, once a plurality of models are generated, the system can be utilized to automatically determining the appropriate model for comparison with a raw recorded waveform.

In order to achieve this the system can be configured to compare two or more architectures for condition detection. In order to achieve this the system can apply a feed forward deep neural network (DNN) SNR classification model and a 1-D convolutional neural network (CNN) model. The feed forward model can include 4 hidden layers, wherein dropout regularization can be applied when training.

To alleviate edge effects, the system can apply a windowing function to concatenate each center frame with equal number of adjacent frames preceding or after it. The CNN model can then also adopt windowed frames as inputs, which can consist of two interleaving convolutional and max-pooling layers. Dropout regularization can also similarly be used for training in this manner.

With regard to features, the system can be utilized to leverage existing features that are already computed for ASR. The first are frame-based variants of both low-resolution and high-resolution MFCC, the second are utterance-based i-vectors.

The system can then be utilized to train a feed forward deep neural network (DNN) SNR classification model with the standard frame-based MFCC with deltas and double-deltas. In some embodiments Pitch features (dimension 3) can also be added since this is standard for Chinese ASR. The total feature vector per frame is thus 13 MFCC+3 pitch, times 3 for deltas and double-deltas, for a total of 48.

MFCC-based condition accuracy metrics can be first calculated on a frame-by-frame basis, then also on a per-utterance basis. There are two methods used to generate utterance class estimates from frame-by-frame estimates:

The first method being Softmax: which treats the frame-based softmax scores as probabilities, and calculate the joint probability of a class given the estimates until the current frame.

The second method is by majority voting: which chooses the class that as the most frame-by-frame votes. Such voting techniques have been useful with model combination techniques.

For generating the utterance-level class estimates, the system can use both the entire utterance, but also various values (e.g., 250 ms, 500 ms) of using only the first portion of the utterance. This is important for real-time operation, where in order to eliminate additional latency, the system can be utilized to estimate the noise condition and thus select the ASR model as early as possible into the utterance.

Another feature which can be utilized by the system is i-vectors, which have been shown to be successful for speaker verification and for speaker adaptation with ASR. I-vectors are single vectors that code relevant information about both the speaker and the session.

In some embodiments, the various training utterances per class or the noise and/or other conditions, as with i-vectors, were calculated on high resolution (40 instead of the usual 13). MFCCs which were both speed- and volume-perturbed in order to reduce the sensitivity to speaking rate and volume. In some such embodiments the dimension of the i-vectors was 100.

For post-processing, the effectiveness of an i-vector at any time step in an utterance is studied, and it may not be necessary to apply the sliding window idea as used for MFCC post-processing. i-vectors were calculated in online mode, so there was a running estimate of an utterance's i-vector starting at the beginning of the utterance.

In some embodiments, condition accuracy measures can be implemented which can be based on a number of variables such as architecture (feed-forward DNN or CNN), base feature (MFCC or i-vector), pitch features or not, MFCC vector size (standard 13 or “hires” 40), amount of training data, and MFCC combination method (softmax or majority voting).

The effectiveness of the combination methods for MFCC are studied, as i-vectors are utterance-based and not frame-based. As softmax outperforms majority voting for many features, softmax is employed in the examples below.

In some embodiments, some improvement can be realized by having more than 2000 training samples per class.

It will then be appreciated that 98% of errors realized were a mis-classification of a condition as the “next door” condition, e.g., choosing 5 dB or 15 dB for a ground truth of 10 dB. The overall impact of such errors may be substantially lower than for example choosing 20 dB or clean instead of 5 dB.

In some embodiments the ASR system can use the AiShell Kaldi recipe, which uses mono-phone then triphone-based GMM models, using first MFCCs plus deltas and then multiple-frame LDA plus MLLT, then speaker adaptation using fMLLR, and finally the DNN “chain” model incorporating online iVectors for speaker characteristics.

In some embodiments, the system can utilize only the language model (LM) trained from the corpus, which could then allow for substantially lower complexity than large general LMs used in the 3rd-party ASR engines.

On one hand, this biases any performance comparison strongly in favor of the custom trained system; on the other hand, from a bottom-line performance standpoint, the ability to craft custom LMs for application domains is a great advantage of custom-trained ASR engines over “black-box” approaches, and can be ignored.

Engine2 and Engine4: these are the best-performing models from FIG. 7A.

Multi-condition, speaker only: multi-condition training is used, i.e., a single model is trained with all noise conditions. The “speaker” for speaker adaptation is only the corpus speaker.

Multi-condition, speaker and condition: same as above, but the “speaker” can instead be a combination of speaker and condition.

Single-condition, ground truth: there are several models, one for each condition, and it is assumed that the actual noise is known.

Single-condition, predicted, entire utterance: there are several models, one trained on each noise condition, and the condition is estimated from the speech using the techniques mentioned above, using the entire utterance.

Single-condition, predicted, first part of utterance: Same as above, but only using the first 250 ms of the utterance. This is more realistic for real-time deployment.

In some situations, such as for SNRs less than 15 dB, the custom-trained models performed somewhat better than prior art models. Multi-condition training performed as well as single-condition training for SNRs greater than 5 dB, so for a majority of use cases, the extra effort, both from training and run-time perspectives, of using single-condition training does not currently appear to be advantageous. However, using speaker+condition as opposed to only speaker did provide some small benefits at low SNR.

The single-condition results using the condition identification can be either similar or better than the results from single-condition models assuming the noise level was known a priori. Even more striking is that that the ASR performance is often the same or better using the first 250 ms of the utterance versus using the entire utterance. This is notwithstanding the fact, as might be expected, the condition classification accuracy was lower using the first 250 ms as opposed to using the entire utterance (76% v. 90%).

The better performance with predicted noise conditions could be explained by the utterance-by-utterance variability of SNR. Recall from above that for each average SNR condition, the standard deviation of the utterance-specific SNR was 5 dB due to the inherent variability in the corpus signal level. It could thus be that the condition detector is choosing the specific SNR for a particular utterance, which is more accurate than using the average SNR for the condition. This makes sense especially when considering that with a 5 dB standard deviation and 5 dB steps, 60% of the utterances will have an SNR closer to the average of another category than the average of their own.

Similarly, this may explain the better ASR performance with lower condition classification accuracy. Since most of the utterances for a particular average SNR class may actually have an utterance-specific SNR closer to another class, it is reasonable that higher classification accuracy could hurt ASR performance.

The high variability of utterance-specific SNR suggests that there may be some benefit training the condition classifier on utterance SNR and not average SNR.

In some embodiments, the open source portion of the AiShell-1 corpus can be provided with 148 hours of training data; however, up to 718 hours of additional AiShell data can be provided.

FIG. 8 shows the single-noise CER as a function of the number of hours of training data, for various noise conditions.

In some embodiments, the system can be provided with improved single condition performance by clustering the speech data into independent categories.

Other languages: in some embodiments the system can be expanded to incorporate English with the Libri-speech corpus and Japanese with the CSJ corpus, both of which have established Kaldi recipes.

De-noising autoencoders: as referenced earlier, de-noising auto-coders (DAE) have been successful in feature-space reduction in the effects of noise. In some embodiments of the present invention the system can use de-noising auto-encoders in combination with the other techniques described such as multi-condition training.

Microphone arrays: especially for social robots in public spaces with multiple possible speakers, sometime simultaneous, it would be useful to use multiple micro-phones to detect the live speaker and also focus attention on that speaker, decreasing the effective SNR as compared with single microphones.

Audio-visual speech recognition: in some embodiments, especially for SNR less than 20 dB, the system can be provided having a camera, wherein the system can also be trained on visual speech capture wherein audio-visual speech recognition or “lipreading” can improve ASR performance, sometimes dramatically.

In the system contemplated herein, significant ASR and STT accuracy was able to be achieved by identifying the noise condition so that the best associated linguistic model can be chosen for raw waveform comparison, by doing so the system was able to identify the noise condition with greater than 90% accuracy, and when adding such predictions to the ASR system, overall performance was the same or better than if the system had known the average SNR a priori. Multi-condition training performed as well as single-condition training for all but very low SNR, less than 10 dB.

In some embodiments the raw audio waveform can be recorded on a local computational device, and wherein method further comprises a step of transmitting the raw audio waveform to a remote server, wherein the remote server contains the computational neural network.

Alternatively, the raw audio waveform can be recorded on a local computational device, and wherein the local computational device contains the computational neural network. In some such embodiments, the computational neural network, when provided on a local device, can be compressed.

The foregoing has provided a detailed description on a system and method of employing multi-model automatic speech recognition in challenging acoustic environments according to some embodiments of the present disclosure. Specific examples are used herein to describe the principles and implementations of some embodiments.

In the above embodiments, the existing functional elements or modules can be used for the implementation. For example, the existing sound reception elements can be used as microphones; at least, headphones used in the existing communication devices have elements that perform the function; regarding the sounding position determining module, its calculation of the position of the sounding point can be realized by persons skilled in the art by using the existing technical means through corresponding design and development; meanwhile, the position adjusting module is an element that any apparatuses with the function of adjusting the state of the apparatus have.

In some embodiments, the control and/or interface software or app can be provided in a form of a non-transitory computer-readable storage medium having instructions stored thereon is further provided. For example, the non-transitory computer-readable storage medium may be a ROM, a RAM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube) display, an LCD (liquid-crystal display) display, an OLED (organic light emitting diode) display, a plasma display, a flexible display, or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

For the convenience of description, the components of the apparatus may be divided into various modules or units according to functions, and are separately described. Certainly, when various embodiments of the present disclosure is carried out, the functions of these modules or units can be achieved in one or more hardware or software.

Persons skilled in the art should understand that the embodiments of the present invention can be provided for a method, system, or computer program product. Thus, the present invention can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure is described with reference to the flow diagrams and/or block diagrams of the method, apparatus (system), and computer program product of the embodiments of the present invention. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory that can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Although preferred embodiments of the present invention have been described, persons skilled in the art can alter and modify these embodiments once they know the fundamental inventive concept. Therefore, the attached claims should be construed to include the preferred embodiments and all the alternations and modifications that fall into the extent of the present invention.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

1. A speech recognition method comprising:
providing a system having a local computational device, the local computational device having a microphone, processing circuitry, and a non-transitory computer-readable medium;
recording a raw audio waveform utilizing the microphone;
determining a background noise condition for the raw audio waveform;
comparing the background noise condition to a plurality of linguistic models having associated background noise conditions;
determining a nearest match between the background noise condition of the raw audio waveform and the associated background noise condition of at least one of the plurality of linguistic models; and
performing an automatic speech recognition (ASR) function between the raw audio waveform and the linguistic model having the matching associated background noise condition.

2. The speech recognition method of claim 1, further comprising:
providing a remote server;
providing a database containing a plurality of linguistic models and associated background noise conditions for each linguistic model;
providing a computerized neural network on the remote server;
wherein the computerized neural network is configured to determine the nearest match between the background noise condition of the raw audio waveform and the associated background noise condition of a particular linguistic model.

3. The speech recognition method of claim 1, further comprising:
providing a database containing a plurality of linguistic models and associated background noise conditions for each linguistic model;
providing a computerized neural network on the local device;
wherein the computerized neural network is configured to determine the nearest match between the background noise condition of the raw audio waveform and the associated background noise condition of a particular linguistic model.

4. The speech recognition method of claim 3, wherein the computerized neural network is compressed.

5. The speech recognition method of claim 1, further comprising:
extracting textual characters representing speech within the raw audio waveform.

6. The speech recognition method of claim 5, further comprising:
tracking user interactions with the local computational device;
determining corrections to the textual characters extracted from the raw audio waveform.

7. The speech recognition method of claim 4, further comprising:
generating a new linguistic model with an associated background condition based on an original base truth from an original linguistic model and creating a new linguistic model based on an extracted background noise condition;
inserting the new linguistic model into the plurality of linguistic models contained on the database for future consideration by the computerized neural network in future match determination functions.

8. The speech recognition method of claim 1, wherein each of the plurality of linguistic models are representative of a single language model recorded in a plurality of associated noise condition, wherein the only variation between each linguistic model is their particular associated noise conditions.

9. The speech recognition method of claim 1, wherein the plurality of linguistic models include a plurality of language models, each being recorded in a plurality of associated noise condition, wherein each linguistic model can vary with regard to particular associated noise conditions as well as an underlying language represented thereby.

10. A speech recognition system, the system comprising:
a local computational system, the local computational system further comprising:
processing circuitry;
a microphone operatively connected to the processing circuitry;
a non-transitory computer-readable media being operatively connected to the processing circuitry;
a remote server configured to receive recorded wavelengths from the local computational system; the remote server having one or more computerized neural networks, wherein the computerized neural networks of the remote server are trained on a plurality of acoustic models, wherein each of the plurality of acoustic models represent a particular linguistic dataset recorded in one or more associated noise predetermined signal to noise ratios;
wherein the non-transitory computer-readable media contains instructions for the processing circuitry to perform:
utilizing the microphone to record raw audio waveforms from an ambient atmosphere;
transmitting the recorded raw audio waveforms to the remote server; and
wherein the computerized neural network is configured to determine the nearest match between the background noise condition of the raw audio waveform and the associated background noise condition of a particular linguistic model.

11. The speech recognition system of claim 10, wherein the computerized neural network is further configured to extract textual characters representing speech within the raw audio waveform.

12. The speech recognition system of claim 11, wherein the computerized neural network is further configured to track user interactions with the local computational device and determine corrections to the textual characters extracted from the raw audio waveform.

13. The speech recognition system of claim 12, wherein the computerized neural network is further configured to generate a new linguistic model with an associated background condition based on an original base truth from an original linguistic model and creating a new linguistic model based on an extracted background noise condition; and insert the new linguistic model into the plurality of linguistic models contained on the database for future consideration by the computerized neural network in future match determination functions.

14. The speech recognition system of claim 10, wherein each of the plurality of linguistic models are representative of a single language model recorded in a plurality of associated noise condition, wherein the only variation between each linguistic model is their particular associated noise conditions.

15. The speech recognition system of claim 10, wherein the plurality of linguistic models include a plurality of language models, each being recorded in a plurality of associated noise condition, wherein each linguistic model can vary with regard to particular associated noise conditions as well as an underlying language represented thereby.

16. A robotic apparatus comprising a speech recognition system, the system comprising:
a local computational system, the local computational system further comprising:
processing circuitry;
a microphone operatively connected to the processing circuitry;
a non-transitory computer-readable media being operatively connected to the processing circuitry;
one or more computerized neural networks;
wherein the non-transitory computer-readable media contains instructions for the processing circuitry to perform:
utilizing the microphone to record raw audio waveforms from an ambient atmosphere; and
wherein at least one computerized neural network is configured to wherein the computerized neural network is configured to determine the nearest match between the background noise condition of the raw audio waveform and the associated background noise condition of a particular linguistic model.

17. The robotic apparatus of claim 16, wherein the computerized neural network is further configured to extract textual characters representing speech within the raw audio waveform.

18. The robotic apparatus system of claim 17,
wherein the computerized neural network is further configured to track user interactions with the local computational device and determine corrections to the textual characters extracted from the raw audio waveform, and
wherein the computerized neural network is further configured to generate a new linguistic model with an associated background condition based on an original base truth from an original linguistic model and creating a new linguistic model based on an extracted background noise condition; and insert the new linguistic model into the plurality of linguistic models contained on the database for future consideration by the computerized neural network in future match determination functions.

19. The robotic apparatus system of claim 16, wherein each of the plurality of linguistic models are representative of a single language model recorded in a plurality of associated noise condition, wherein the only variation between each linguistic model is their particular associated noise conditions.

20. The robotic apparatus system of claim 16, wherein the plurality of linguistic models include a plurality of language models, each being recorded in a plurality of associated noise condition, wherein each linguistic model can vary with regard to particular associated noise conditions as well as an underlying language represented thereby.
